(19) United States
(12) Patent Application Publication
(10) Pub. No.: US 2002/0033050 A1
(43) Pub. Date: Mar. 21, 2002

(54) Pressure sensor

(76) Inventors: Toshitaka Shibata, Tokyo (JP); Kazuyuki Ito, Akita-shi (JP); Tatsuya Ito, Akita-shi (JP)

Correspondence Address: Daniel Basov, Chadbourne & Parke LLP, 30 Rockefeller Plaza, New York, NY, 10112, US

(21) Appl. No.: 09/843,046

(22) Filed: Apr. 26, 2001

(30) Foreign Application Priority Data
Apr. 28, 2000 (JP) P2000-131262
Apr. 28, 2000 (JP) P2000-131274

(51) Int. Cl. G01L 9/00

(52) U.S. Cl. 73/754

(57) ABSTRACT

It is an object of this invention to provide a semiconductor pressure sensor which can be used even in an environment where there is contact with gasoline and the like. The pressure sensor of this invention comprises a base, a pressure-sensitive section which receives pressure and is mounted on the base, a pressure injection section which injects gas to be measured into the pressure-sensitive section, and a lead which is connected to the pressure-sensitive section and extracts a pressure detection signal. Furthermore, the pressure-sensitive section is affixed to the base by a flouric elastomer.

### BACKGROUND OF THE INVENTION

1. Field of the Invention

The present invention relates to a pressure sensor which is used in an environment which demands corrosion resistance and/or is susceptible to infiltration of water and the like. More particularly, this invention relates to the pressure sensor for measuring the pressure of gas which is aspired/exhausted to/from an internal combustion engine for motor vehicle and an engine for two-wheel vehicle, and particularly for measuring the pressure of aspired gas.

2. Description of the Related Art

FIG. 1 is a cross-sectional view of a pressure sensor (semiconductor pressure sensor) which the present invention can be applied in, and FIG. 2 is a top view of the semiconductor pressure sensor. In the semiconductor pressure sensor, a concavity 3 is provided in a base 1 of molded resin, and a pair of through-holes 2 are provided on either side of the concavity 3. The through-holes 2 function as holes for pins which prevent wires 14 (explained later) from deviating from their positions, the pins being buried between the base 1 and a rod 4 (explained later) at the time of molding the base 1 and the rod 4. The through-holes 2 are covered by a lid 18.

A resin layer 12 comprises silicon resin, and affixes a stand 10 of silicon or glass to the bottom of the concavity 3. A pressure-sensitive chip 11 converts pressure to an electrical signal, and is mounted on the top face of the stand 10.

The pressure-sensitive chip 11 is a conventionally known chip comprising a thin-film diaphragm, etched in the center of a silicon chip, and creates diffused resistance on the chip face on the diaphragm. The peripheral parts excepting the diaphragm are affixed to the stand 10 by an adhesive or the like, whereby the inner section of the pressure-sensitive chip 11 becomes an airtight space having constant pressure (e.g. zero atmospheric pressure). The diffused resistance value changes as the diaphragm deforms in correspondence with the outside pressure, and the pressure-sensitive chip 11 measures the outside pressure by extracting the change in the diffused resistance value as an electrical signal.

A rod 4 has a through-hole which connects to the through-holes 2, and is molded on top of the base 1 in a single body therewith. The rod 4 increases the sealing capability of an adhesive 17 (explained later). Wires 14 are buried between the base 1 and the rod 4. The wires 14 comprise metallic wire frames, and although only two wires are shown on the left and right of FIG. 1, multiple wires 14 are provided in accordance with the number of electrodes of the pressure-sensitive chip 11. This can be seen when viewed from above as in FIG. 2.

A sensor case comprises a sensor package for enclosing the base 1 and the pressure-sensitive chip 11, and is affixed by a cap adhesive 17 of silicon resin with the rod 4 therebetween. The sensor case comprises a base section 5, having a concavity 8 in the center of its bottom face, and a pipe-like pressure injection section 6 which has a smaller diameter than the base section 5; the pressure injection section 6 forms a single body with the base section 5 and has a central port 7 which connects to the concavity 8. Considering the demand for heat resistance, polyphenylenslufide (PPS) is used as the material for the base 1 and the sensor case.

The pressure-sensitive chip 11 is connected to the wires 14 by leads (terminals) 13 which comprise, for example, metal wires. A lead sealing section 15 is provided at the junction between the leads 13 and the wires 14. The top face of the pressure-sensitive chip 11 is covered with a protective resin layer 20 of a silicon resin gel.

The semiconductor pressure sensor is used in measuring engine aspiration pressure by connecting the pressure injection section 6 to, for example, the pipe of an aspiration manifold of the engine of a motor vehicle and the engine of a two-wheel vehicle, or to a pipe which has been branched from the aspiration manifold. In this case, aspired air is drawn in from a port 7, the diaphragm of the pressure-sensitive chip 11 deforms in correspondence with the pressure of the aspired air, and the pressure converted to an electrical signal. As a result, the aspired air pressure is fed to the outside by the wires 14 as an electrical signal, and is measured. By optimizing the aspired air pressure, fuel consumption efficiency can be increased and exhaust gas can be made cleaner.

As described above, the silicon resin is conventionally used for the resin layer 12, which affixes the base 1 and the pressure-sensitive chip 11, and the cap adhesive 17, which affixes the base 1 to the sensor case. However, the silicon resin has low chemical resistance, and is liable to peel in an environment where it may contact gasoline and the like, e.g. near engine components such as the above-mentioned aspiration manifold. For this reason, the silicon resin has a drawback that there are cases where it cannot be used in the semiconductor pressure sensor. There is a further drawback that the pressure-sensitive chip 11 itself tends to be corroded by gasoline and the like.

In the semiconductor pressure sensor, the gel which protects the pressure-sensitive chip 11 is pasted only to the top face of the pressure-sensitive chip 11, and not to the leads 13 which connect the pressure-sensitive chip 11 and the wires 14. Consequently, the leads 13 are unprotected.

For this reason, when a conductive fluid or a substance which electric current flows in, such as water, has infiltrated the sensor package, current flows through the wires 14 and the pressure sensor becomes unable to output accurate measurements, making it impossible to accurately measure the pressure. Moreover, it is apprehended that additives and the like in the gasoline will corrode the wires 14 themselves, causing them to become broken.

The present invention is achieved in consideration of the problems described above, and aims to provide a semiconductor pressure sensor which can be used even in an environment where there may be contact with gasoline and the like.

It is another object of this invention to provide a semiconductor pressure sensor which can accurately measure pressure and has excellent corrosion resistance even when a conductive fluid or a substance, such as water, which current flows through, has infiltrated the sensor package.

### SUMMARY OF THE INVENTION

A pressure sensor according to a first aspect of this invention comprises a base; a pressure-sensitive section which receives pressure and is mounted on the base; a pressure injection section which injects gas to be measured into the pressure-sensitive section; and a lead which is connected to the pressure-sensitive section and extracts a pressure detection signal. The pressure-sensitive section is affixed to the base by a flouric elastomer.

Preferably, the pressure-sensitive section is enclosed by a sensor package comprising multiple members which are affixed by a flouric elastomer.

A pressure sensor according to a second aspect of this invention comprises a base; a pressure-sensitive section which receives pressure and is mounted on the base; a pressure injection section which injects gas to be measured into the pressure-sensitive section; a lead which connects a terminal of the pressure-sensitive section to a wire, provided on the base, and extracts a pressure detection signal; and a resin which covers the pressure-sensitive section and the lead.

In this aspect, the resin should preferably be a flouric gel.

Preferably, the pressure-sensitive section and the base are affixed by a flouric elastomer which is harder after solidification than the flouric gel.

Furthermore, the pressure-sensitive section should preferably be enclosed by a sensor package comprising a plurality of members which are affixed by a flouric elastomer which is harder after solidification than the flouric gel.

The pressure sensor is used, for example, in measuring the aspired air of an engine. In this case, the pressure sensor is provided, for example, in a aspired air manifold of the engine.

### BRIEF DESCRIPTION OF THE DRAWINGS

FIG. 1 is a cross-sectional view of a semiconductor pressure sensor which the present invention can be applied in;

FIG. 2 is a top view of the semiconductor pressure sensor shown in FIG. 1; and

FIG. 3 is a cross-sectional view of a semiconductor pressure sensor according to a second embodiment of this invention.

### DESCRIPTION OF THE PREFERRED EMBODIMENTS

Preferred embodiments of this invention will be explained with reference to the accompanying drawings.

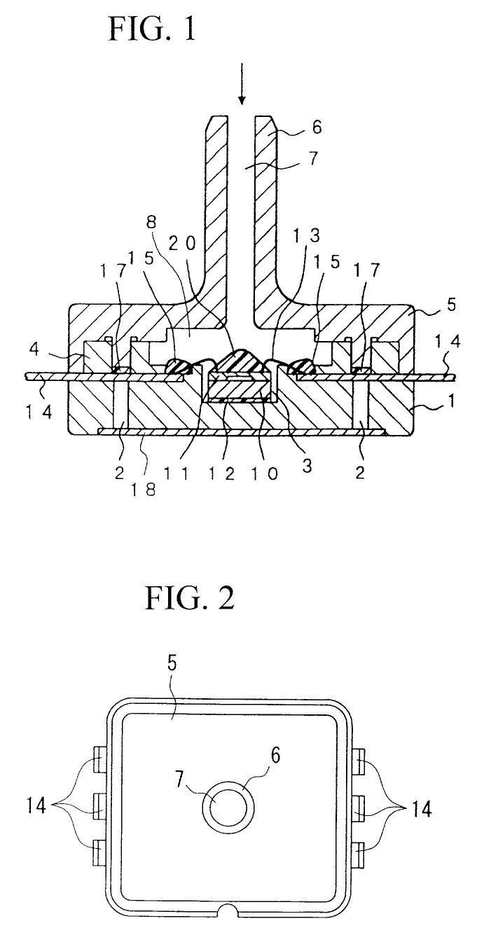

Firstly, the semiconductor pressure sensor according to a first embodiment of this invention will be explained with reference to FIGS. 1 and 2. The members shown in FIGS. 1 and 2 which are identical to those already mentioned in the above description of the conventional art will not be explained further. These members are used in an identical manner to that explained in the conventional art.

In the semiconductor pressure sensor according to this embodiment, a flouric elastomer, which has rubber-like elasticity after solidification, is used for a resin layer 12 which affixes a base 1 to a stand 10, which a pressure-sensitive chip 11 is mounted on, and for a cap adhesive 17 which affixes the base 1 to the sensor package. For example, SIFEL614 (commercial name) manufactured by Shinetsu Chemical Industries Corporation can be used as this flouric elastomer. After solidification, this resin has shearing adhesion to PPS of 15 kgf/cm² at a thickness of 0.08 mm.

According to the semiconductor pressure sensor of this embodiment, since the flouric elastomer, used as the substance for the resin layer 12 and the cap adhesive 17, is a resin having excellent chemical resistance and corrosion resistance, the resin layer 12 and the cap adhesive 17 do not deteriorate even when they make contact with gasoline and the like being aspired. Therefore, the pressure-sensitive chip 11 and the sensor case do not peel from the base 1, making it possible to measure the pressure of aspired air containing gasoline and the like. Since the flouric elastomer has excellent heat resistance, it can be used in high-temperature environments. That is, according to the present embodiment, it is possible to provide a semiconductor pressure sensor having excellent durability, even in the case where the pressure sensor is connected midway in the aspired air manifold of an engine in order to measure the engine aspired air pressure, and is used around the engine of a motor vehicle or two-wheel vehicle, this being a comparatively high-temperature environment and a corrosive atmosphere for the semiconductor pressure sensor.

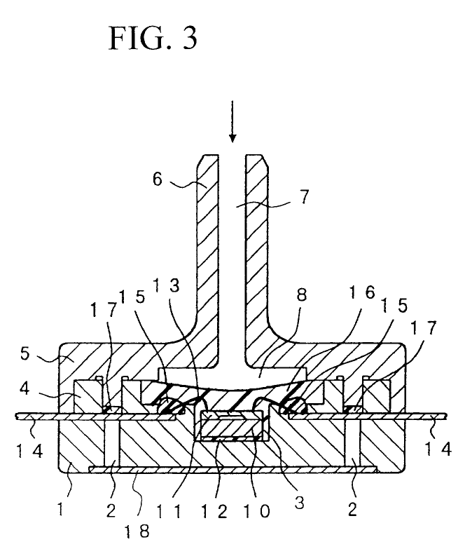

FIG. 3 is a cross-sectional view of a semiconductor pressure sensor according to a second embodiment of this invention. The members shown in FIG. 3 which are identical to those already mentioned in the description of the conventional art will not be explained further.

In the semiconductor pressure sensor according to this embodiment, the concavities 3 and 8 are filled with resin, thereby providing a protective resin layer 16 which is thick enough to cover at least the pressure-sensitive chip 11, the leads 13, and the lead sealing section 15, without closing-up the pressure input section.

In the semiconductor pressure sensor according to this embodiment, the same flouric elastomer as that in the first embodiment is used for the resin layer 12 and the cap adhesive 17. Furthermore, a flouric gel, which loses fluidity after solidification but remains flexible (more flexible than the above-mentioned flouric elastomer), is used as the substance for the protective resin layer 16. For example, SIFEL857 (commercial name) manufactured by Shinetsu Chemical Industries Corporation can be used as this flouric gel. After solidification, this resin has penetration of 70, based on the Japan Industrial Standard (JIS) K2220.

According to the semiconductor pressure sensor of the present invention, since the protective resin layer 16 covers the pressure-sensitive chip 11, the leads 13 and the lead sealing section 15, even in the case where the aspired air contains a conductive fluid and a substance which current flows through, such as water, and the fluid and substance infiltrate the sensor package, making the atmosphere around the pressure-sensitive chip 11 capable of conducting by electricity, no electricity flows between the wires 14. Consequently, the pressure signal from the pressure-sensitive chip 11 is accurately led out, whereby the aspired air pressure can be accurately measured and controlled with high precision. Further, since the pressure-sensitive chip 11 is protected by the protective resin layer 16, the pressure-sensitive chip 11 is affixed more securely, increasing durability.

According to the semiconductor pressure sensor of the present invention, the flouric elastomer and flouric gel, which are resins having excellent chemical resistance and corrosive resistance, are used as the material for the resin layer 12, the cap adhesive 17, and the protective resin layer 16. Therefore, the resin layer 12, the cap adhesive 17, and the protective resin layer 16 do not deteriorate even when they contact gasoline and the like contained in the aspired air, making it possible to measure the pressure of aspired air containing gasoline and the like. Furthermore, since the flouric elastomer and flouric gel have excellent heat resistance, they can be used in high-temperature environments. That is, the present invention can provide a semiconductor pressure sensor having excellent durability even when connected midway in the aspired air manifold of an engine to measure the engine aspired air pressure, and when used around the engine of a vehicle or two-wheel vehicle, this being a comparatively high-temperature environment and a potentially corrosive atmosphere for the semiconductor pressure sensor.

The semiconductor pressure sensor of the present invention can be used not only in measuring the aspired air pressure of the engine of a vehicle or two-wheel vehicle, but also in measuring, for example, the pressure of exhaust gas from such engines. Moreover, the semiconductor pressure sensor according to the present invention is capable of measuring not only aspired air but also, for example, corrosive fluid. The pressure-sensitive chip is not limited to a semiconductor pressure-sensitive chip having a diaphragm, and may comprise another type of chip.

The examples shown in FIGS. 1 to 3 comprise the stand 10 and the pressure-sensitive chip 11, but the pressure-sensitive section may be comprised only of the pressure-sensitive chip 11. That is, the present invention can also be applied in a pressure sensor which does not have a stand 10 and is directly mounted on the base 1.

What is claimed is:

1. A pressure sensor comprising:
a base; a pressure-sensitive section which receives pressure and is mounted on said base; a pressure injection section which injects gas to be measured into said pressure-sensitive section; and a lead which is connected to said pressure-sensitive section and extracts a pressure detection signal; said pressure-sensitive section being affixed to said base by a flouric elastomer.

2. The pressure sensor as described in claim 1, wherein said pressure-sensitive section is enclosed by a sensor package comprising a plurality of members which are affixed by a flouric elastomer.

3. A pressure sensor comprising:
a base; a pressure-sensitive section which receives pressure and is mounted on said base; a pressure injection section which injects gas to be measured into said pressure-sensitive section; a lead which connects a terminal of said pressure-sensitive section to a wire, provided on said base, and extracts a pressure detection signal; and a resin which covers said pressure-sensitive section and said lead.

4. The pressure sensor as described in claim 3, wherein said resin is a flouric gel.

5. The pressure sensor as described in claim 4, wherein said pressure-sensitive section and said base are affixed by a flouric elastomer which is harder after solidification than said flouric gel.

6. The pressure sensor as described in claim 4, wherein said pressure-sensitive section is enclosed by a sensor package comprising a plurality of members which are affixed by a flouric elastomer which is harder after solidification than said flouric gel.

7. The pressure sensor as described in claim 5, wherein said pressure-sensitive section is enclosed by a sensor package comprising a plurality of members which are affixed by a flouric elastomer which is harder after solidification than said flouric gel.

8. The pressure sensor as described in one of claims 1 to 7 which is used in measuring the aspired air of an engine.

9. The pressure sensor as described in claim 8 which is provided in a aspired air manifold of an engine.
